(19) United States
(12) Patent Application Publication
(10) Pub. No.: US 2009/0055751 A1
(43) Pub. Date: Feb. 26, 2009

(54) Management System for Local and Remote Services

(75) Inventors: Adam DePue, Redmond, WA (US); Paul Fitzgerald, Woodinville, WA (US); Mithun Arora, Redmond, WA (US); Jonathan A. Hoover, Kirkland, WA (US); Kevin Kean, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/844,808

(22) Filed: Aug. 24, 2007

(51) Int. Cl. G06F 3/00

(52) U.S. Cl. 715/740

(57) ABSTRACT

A management system for a computer service may have a single set of interfaces through which a local or remote version of the service may be administered. The management system may include a discovery system that determines if a service is provided through a local or remote host and uses the appropriate routines or connections to perform each administrative task. The management system may include a single set of console interfaces, wizards or sequential interactive interfaces, dialog boxes, or other user interface mechanisms that may be used to control a local or remote version of a service.

### BACKGROUND

Many services may be available as local or remote services. One example may be an email service. In a local version, a local email server may operate an email service that processes and stores email for various email accounts. The local server may connect with a network to send, receive, and route email appropriately, as well as give users various mechanisms for storing, sorting, editing, and sending email. A remote version of such a service may be hosted on a remote server accessed over the Internet or other wide area network.

Management systems may be used by an administrator or in some cases by a user to perform various administrative tasks, such as setting up user accounts, setting permissions, configuring a service, or some other tasks.

### SUMMARY

A management system for a computer service may have a single set of interfaces through which a local or remote version of the service may be administered. The management system may include a discovery system that determines if a service is provided through a local or remote host and uses the appropriate routines or connections to perform each administrative task. The management system may include a single set of console interfaces, wizards or sequential interactive interfaces, dialog boxes, or other user interface mechanisms that may be used to control a local or remote version of a service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a set of network connected devices that may use management interfaces for remote services or local applications.

FIG. 2 is a diagram illustration of an embodiment showing a management system for remote services or local applications.

FIG. 3 is a flowchart illustration of an embodiment showing a method for managing local applications and remote services.

### DETAILED DESCRIPTION

A single user interface is used to manage services that may be provided in a local or remote version. A local version may be provided on a user device or a server on a local area network as a locally operating application. A remote version may be provided over the Internet or a wide area network. Many services, such as email hosting, shared file directories, or various applications may be available in both local and remote versions.

A management system may have a single user interface to collect information, display information, and receive input to perform various tasks. The management system may have a detection or discovery system by which the management system may detect and select the local or remote version of the service with which to communicate. Once the version is determined, the management system may select an interface to the appropriate version and communicate on that interface.

The user interface may use a console, dialog boxes, wizards, and other user interface tools to collect information and perform various actions on the service for administrators and users of the service. Each version of a service may have a standardized protocol and data interface so that the user experience is identical for either a locally hosted or remotely hosted service.

Remote services may be any type of service that is accessed over a network connection, including services provided over the Internet. Such services may involve access to specialized databases, remote file storage system, or other information. In many cases, the service may restrict general access to the data and may use authentication or other access control to allow only registered users to access the data.

Local versions of a service may be an application that is installed and operated on a local server. The purchase and licensing mechanism for local versions and remote versions may differ. In a local version, a software license may be purchased for the local use of a software product. Such software may be installed and operated on a local device and may have various software protection mechanisms that may limit the use of the software per the license agreement. In some cases, the local software may be purchased outright and may be expensed or capitalized by the owner. Remote services may be purchased on a subscription basis. Some subscriptions may be based on the number of users or connections, the amount of data transferred, or some other basis. A typical subscription may have a recurring cost. Remote services sometimes differ from local versions of a service in that the ownership of the software providing the service may not transfer to the user.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

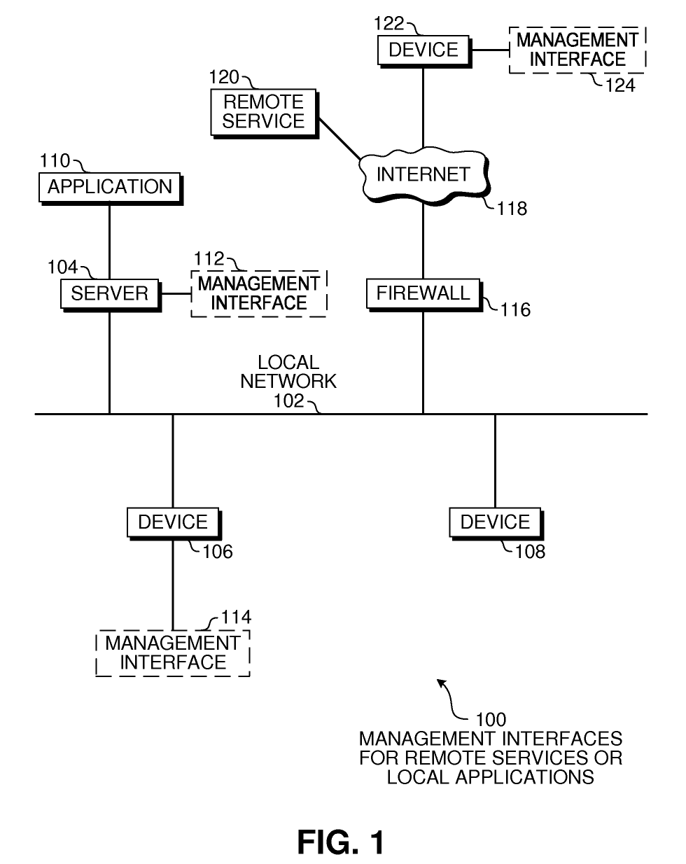

FIG. 1 is a diagram of an embodiment 100 showing a network of devices with management interfaces for local applications or remote services. Embodiment 100 illustrates several different configurations of a system that uses a single management interface for services that may be provided locally as local applications or remotely as remote services.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functionality described.

A local network 102 has connections to a local server 104 and devices 106 and 108. The network 102 may be any type of network by which the various devices may be connected. In some cases, the network 102 may be a hardwired network while in other cases, the network 102 may be a wireless network. Some cases may use a combination of wired and wireless technologies. The local network 102 may be any network whereby the various devices may connect to the server 104.

The server 104 may have an application 110 that is executed on the server 104. The application 110 may be any service, program, function, interface, or executable or non-executable data that may be accessed by another device connected to the server 104 through the network 102. Typical examples of the application 110 may be a shared directory service, an email service, an accounting application, a customer relationship management system, an interactive game system, or any other function that may be imagined. In some cases, the application 110 may represent a database of information that is accessed locally through the server 104.

The application 110 may have a corresponding remote service 120 that may be accessed through the firewall 116 and the Internet 118.

The remote service 120 may be a version of the application 110 that is provided over the Internet 118. In many cases, the remote service 120 may be a subscription based service that may provide similar functionality to the application 110 that may be purchased and operable on the server 104. In many cases, the remote service 120 may have a different programmatic interface than the application 110.

In many cases, the application 110 may be a software product that is installed to be executed on the server 104. Such a software product may be provided on a set of installation disks or downloaded to the server 104. The application 110 may be executed by a processor on the server 104. In many cases, the application 110 may be purchased or licensed to operate on the server 104. Many such licensing agreements may enable the application 104 to be executed on the server 104 for a limited period of time or in perpetuity for the specific hardware configuration. Many variations of such licensing agreements may be used for the application 110.

The remote service 120 may be a version of the application 110 that is provided on remote hardware. In many cases, the remote service 120 may be provided for many users and may be operated on large servers or a plurality of servers. The remote service 120 may be a subscription based service, where a fee may be paid for access to the service 120 for a period of time. In some embodiments, a licensing arrangement may be provided for certain number of users, connections, amount of data, or some other factor.

The server 104 may have a management interface 112 that may enable a user or administrator to access either the local application 110 or remote service 120 for administrative and management tasks. The management interface 112 may be hosted on the server 104 or a management interface 114 may be hosted on a device 106.

The management interfaces 112 and 114 may allow a user or administrator to perform various functions with either the local application 110 or the remote service 120. In some embodiments, the user or administrator may not be aware which of the application 110 or the remote service 120 is being administered.

The management interfaces 112 and 114 may be configured so that a single user interface experience is used to control either the local application 110 or the remote service 120. The same or similar dialog boxes, wizards, consoles, or other user interface mechanisms may be used for either the local application 110 or the remote service.

In many embodiments, the connections and interfaces may be quite different between a local application 110 and a remote service 120. A remote service 120 may use various network connection and authentication routines to establish a connection whereas a connection to a local application 110 may use different connection and authentication mechanisms.

In some cases, the remote service 120 may be a web based service that uses a web interface for the predominant user interface whereas the application 110 may have use a client on the various devices 106 and 108 to connect with the application 110. Even though the remote service 120 and application 110 may have different user interfaces, the management interfaces 112 and 114 may be separate user interfaces for administrative and management activities, as opposed to the user interface generally used for interacting with the functional portion of the application 110 and remote service 120.

The management interface 112 that is operable on the server 104 may be a client or standalone application that executes on the server 104 and enables a user of server 104 to administer or manage the application 110 or remote service 120 with a unified user interface. In some embodiments, the management interface 112 may be provided through an application or client operating on the server 104 but accessed by one of the various devices 106 or 108. In such an embodiment, the management interface 112 may be provided through a web based interface served through a web server application on the server 104.

The management interface 114 may be operable on the device 106 and may be used to manage and administer the application 110 or remote service 120. In some embodiments, the management interface 114 may be a standalone application or client that may execute on the device 106.

The device 122 may be connected to the Internet 118 and be used to access the application 110 or remote service 120. In such a case, the device 122 may connect to the local network 102 through a virtual private network (VPN) or some other secure connection. In some cases, the device 122 may be able to connect to the local network 102 and server 104 without various security mechanisms. The device 122 may have a management interface 124 that may be able to connect to and administer the application 110 and the remote service 120.

In many embodiments, an overall solution encountered by a user may use a portion of the local application 110 and a portion from the remote service 120. In some cases, features, data, or functionality for an overall solution may be switched between locally provided functionality and functionality from a remote service. In such cases, one of the management interfaces 112, 114, or 124 may be used to select a source for a particular feature, be it from a local application 110 or a remote service 120.

Examples of a local application 110 or remote service 120 may include a shared file system. In a local version of a shared file system, the server 104 may store various files, authenticate users, and allow various users certain permitted activities with the stored files. In a remote version, the shared file system may be physically located on a remote server and accessed through the Internet 118. In the remote version, a user device 106, 108, or 122 may connect to the remote service 120 using a VPN connection, a web browser, or some other mechanism.

Another example may include an email system. In a local version of an email system, the server 104 may download and store email in individual mailboxes for each user to access. The email system may send and receive email, provide routing, presence information, and other messaging services. An email system may use a generic interface, such as a web browser, or a client interface that operates on device used to access the email system. In a remote version of an email system, the same services may be performed by the remote service 120 as the application 110. In some such email systems, a user may not be able to distinguish an email system from a local application 110 or a remote service 120.

Still another example may include an update system. Update systems may distribute updates to applications or datasets on servers or clients for operating systems, applications, and datasets used by various devices. For example, an operating system may have updates that are distributed and installed periodically. Anti-virus applications may have virus definition datasets that are distributed and installed on a regular basis. Individual applications may have upgrades or updates that are available from time to time. Update systems may be configured to register various devices for updating, implement the updates, and keep track of the devices that have received the various updates. In a local application version of such a system, the application 110 may receive updates that are distributed to the various devices 106, 108, and 122. In a remote version, the remote service 120 may perform a similar function.

Yet another example may include an email filtering system. An email filtering system may process incoming email for unwanted or unsolicited email. Email may be routed through an email filtering system and the email contents or metadata analyzed to determine if the email is to be sorted, discarded, labeled, or otherwise processed. In a local application 110, an email filtering system may be performed by a local server while a remote service 120 may provide a similar function.

Shared databases may be provided as a local application 110 or as a remote service 120. Such databases may be used by various applications, such as accounting applications, order fulfillment applications, client management applications, docketing applications, or other applications that use a database. In some cases, an application such as an accounting application may operate on a client device but may access a central database that is located as a local application 110 or as a remote service 120. In other cases, the application itself may be located on locally 110 or as a remote service 120 and accessed through a thin client, browser, or other mechanism from various devices 106, 108, and 122.

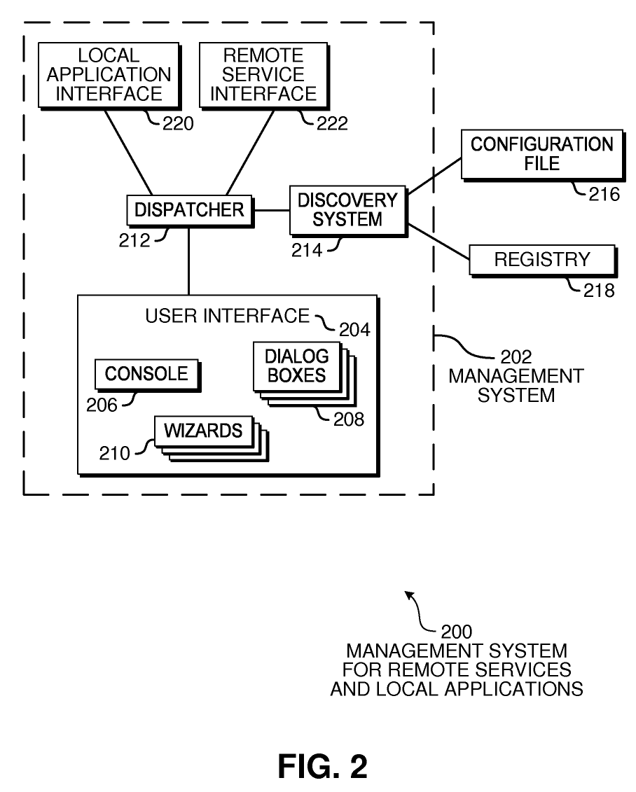

FIG. 2 is a diagram illustration of an embodiment 200 showing a management system for local and remote services. Embodiment 200 is an example of a functional configuration or architecture for a management system 202 that has a common user interface 204 but may maintain and administer a local application or remote service. Other embodiments may have different nomenclature for various functions or may combine or divide the functions described in embodiment 200 in various fashions.

The management system 202 may have a user interface 204 that may be used to display data, obtain input, guide a user, and perform other user interface functions that may be used to control a local application or a remote service. In some embodiments, a single user interface may be used to control either a local application or remote service.

A user interface 204 may include items such as a console interface 206 which may be a graphical or text based user interface that allows interactive control of various functions. Additionally, various dialog boxes 208 and wizards 210 may be used as part of the user interface 204. Other user interface controls and displays may be used as well.

The user interface 204 may send commands to a dispatcher 212. The dispatcher may use a discovery system 214 to determine if a specific command should be sent to a local application interface 220 or a remote service interface 222. The discovery system 214 may read configuration files 216, registry settings 218, or use other mechanisms to determine if a specific command is to be sent to the local application interface 220 or remote service interface 222.

In some instances, an application or service may be configured so that all of the commands processed by the dispatcher 212 are sent to either the local application interface 220 or the remote services interface 222. An example may be where a specific function, such as an email service, is handled exclusively by a remote service and with no local application assistance. In such a case, all commands from the user interface 204 may be sent to the remote service interface 222.

In other instances, some functions may be performed by a local application and other functions by a remote service. In such an instance, individual commands may be analyzed and routed to the appropriate interface.

The local application interface 220 may be used to communicate with a locally operating application. Similarly, the remote service interface 222 may be used to communicate with a remote service. In many cases, the interface and connection requirements may be different between the local application interface 220 and the remote service interface 222.

Embodiment 200 is an example of a single user interface 204 that may be used to control or administer a solution that may be delivered by either a local application or a remote service. Such solutions may have a local application version or a remotely provided service version. In some cases, a user may test a service through a remote service delivery mechanism to evaluate the service on a small scale. After evaluation, a local version of the solution may be installed on a local server for higher throughput or more control of sensitive data. The same user interface 204 may be used to administer the remote version as well as the local version of the same solution.

In another scenario, a local application may be operating on a local server, but as a company grows and more people use the service, the local server may be taxed. At such a point, the service may be partially or completely transferred to a remote service. In either case, the management system 202 may be used to give a unified administrative user interface to the solution, regardless of whether the service is being provided as a local application or as a remote service. In some instances, the management system 202 may be used to manage a solution where a portion of the solution is provided with a local application and the remainder through a remote service.

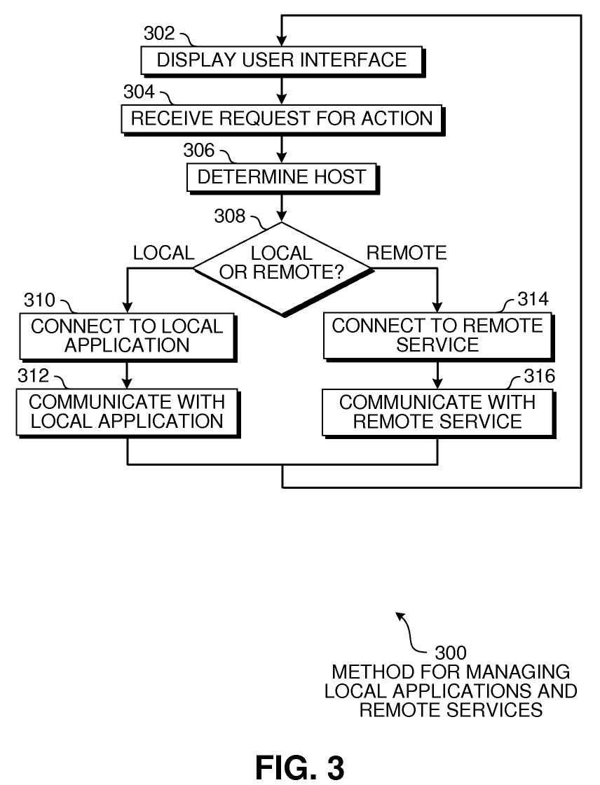

FIG. 3 is a flowchart illustration of an embodiment 300 showing a method for managing local applications and remote services. Embodiment 300 is merely an example of the process or method by which a command may be taken in, routed, and sent to either a local application or a remote service. Other embodiments may use different terminology, different sequencing, and different technology to provide a similar functionality.

A user interface may be displayed in block 302 and a request for action may be received in block 304. The user interface may be any type of user interface, including command line user interface, a scripting user interface, a graphical user interface, and may include various graphical input devices, such as slider bars, radio buttons, knobs, pull down menus, text input boxes, numerical input, buttons, or other input mechanisms.

The request for action in block 304 may be any input that is to be transferred to the solution host. An input may be a command that is executed, and may also include queries, requests for data, active commands, settings or configuration commands, or any other interaction.

The host for the command is determined in block 306. The host may be either a local or remote host in block 308. If the host is a local host in block 308, a connection is made to the local application in block 310 and communication may be performed in block 312. The communication of block 312 may be two way communications.

Similarly, if the host is a remote host in block 308, a connection is made to the remote host in block 314 and one way or two way communication may be performed in block 316.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a user interface adapted to receive input to perform an action on a service;
a first interface to a local version of said service;
a second interface to a remote version of said service;
a discovery system adapted to determine a service location, said service location being a local service or a remote service; and
a service connection adapted to use either said first interface or said second interface based on said service location to perform said action.

2. The system of claim 1, said local service being a service provided via a local area network.

3. The system of claim 1, said remote service being a service provided via a wide area network.

4. The system of claim 3, said remote service having a web based interface.

5. The system of claim 1, said discovery system being further adapted to determine said service location through analyzing a configuration file.

6. The system of claim 1, said discovery system being further adapted to determine said service location through analyzing a registry.

7. The system of claim 1, said remote service comprising at least one of a group composed of:
a file management system;
an email systems;
an update management system;
an email filtering system;
a shared database; and
an application.

8. The system of claim 1, said discovery system further adapted to determine that a first portion of said service is provided through said first interface and a second portion of said service is provided through said second interface.

9. A method comprising:
displaying a user interface;
receiving a request for an action on a service through said user interface;
determining a host for said service, said host being either a local host or remote host;
connecting to said host; and
sending communication to said host to perform said action.

10. The method of claim 9, said user interface comprising at least one of a group composed of:
a console display;
a dialog box; and
a wizard.

11. The method of claim 9, said local host being a service provided via a local area network.

12. The method of claim 9, said remote service being a service provided via a wide area network.

13. The method of claim 12, said remote service having a web based interface.

14. The method of claim 9, said determining a host for said service being performed by analyzing a configuration file.

15. The method of claim 9, said determining a host for said service being performed by analyzing a registry.

16. The method of claim 9, said remote service comprising at least one of a group composed of:
a shared file system;
an email systems;
an update management system;
an email filtering system;
a shared database; and
an application.

17. A computer readable medium comprising computer executable instructions adapted to perform the method of claim 9.

18. A system comprising:
a user interface adapted to receive input to perform an action on a service;
a first interface to a local portion of said service;
a second interface to a remote portion of said service;
a discovery system adapted to determine a service location, said service location being a local server or a remote server; and
a dispatcher adapted to use either said first interface or said second interface based on said service location to perform at least a portion of said action.

19. The system of claim 18, said remote service comprising at least one of a group composed of:
a shared file system;
an email systems;
an update management system;
an email filtering system;
a shared database; and
an application.

20. The system of claim 18, said user interface comprising at least one of a group composed of:
a console display;
a dialog box; and
a wizard.
